(19) United States
(12) Patent Application Publication
(10) Pub. No.: US 2019/0146743 A1
(43) Pub. Date: May 16, 2019

(54) DISPLAY APPARATUS AND NON-TRANSITORY COMPUTER READABLE MEDIUM STORING PROGRAM

(71) Applicant: FUJI XEROX CO., LTD., Tokyo (JP)

(72) Inventors: Eriko IKEDA, Kanagawa (JP); Xiaojing ZHANG, Kanagawa (JP); Hiroo SEKI, Kanagawa (JP)

(73) Assignee: FUJI XEROX CO., LTD., Tokyo (JP)

(21) Appl. No.: 16/182,622

(22) Filed: Nov. 7, 2018

(30) Foreign Application Priority Data
Nov. 15, 2017 (JP) 2017-219915

(51) Int. Cl. G06F 3/14; G06F 3/0482; G06F 3/0488

(52) U.S. Cl. CPC G06F 3/1423; H04N 5/247; G06F 3/04883; G06F 3/0482

(57) ABSTRACT

A display apparatus includes: a first display unit that displays a plurality of display elements on a first display surface, the first display surface being not touch-sensitive; and a second display unit that displays a specific display element on a second display surface, the specific display element being selected from the plurality of display elements displayed on the first display surface, by an operation performed on the second display surface.

### CROSS-REFERENCE TO RELATED APPLICATIONS

This application is based on and claims priority under 35 USC 119 from Japanese Patent Application No. 2017-219915 filed on Nov. 15, 2017.

### BACKGROUND

### Technical Field

The present invention relates to a display apparatus and a non-transitory computer readable medium storing a program.

### SUMMARY

According to an aspect of the invention, there is provided a display apparatus including: a first display unit that displays a plurality of display elements on a first display surface, the first display surface being not touch-sensitive; and a second display unit that displays a specific display element on a second display surface, the specific display element being selected from the plurality of display elements displayed on the first display surface, by an operation performed on the second display surface.

### BRIEF DESCRIPTION OF THE DRAWINGS

Exemplary embodiment of the present invention will be described in detail based on the following figures, wherein:

FIG. 1 is a perspective view of an image processing apparatus according to an exemplary embodiment of the invention;

FIG. 2 is a diagram illustrating an example of a hardware configuration of the image processing apparatus according to the exemplary embodiment of the invention;

FIG. 3 is a block diagram illustrating a functional configuration example of a control device in the exemplary embodiment of the invention;

FIG. 4 is a view illustrating a screen display example during stand-by of the image processing apparatus;

FIG. 5 is a view illustrating a screen display example when login is completed in the image processing apparatus;

FIG. 6 is a view illustrating a screen display example when a print operation is started in the image processing apparatus;

FIG. 7 is a view illustrating a screen display example when file contents are checked in the image processing apparatus;

FIG. 8 is a view illustrating a screen display example when an output format is selected in the image processing apparatus;

FIG. 9 is a view illustrating a screen display example when a print operation is completed in the image processing apparatus;

FIG. 10 is a view illustrating a screen display example when documents are placed by a user on an operation stand;

FIG. 11 is a view illustrating a screen display example when documents are placed by a user on an operation stand;

FIG. 12 is a view illustrating a screen display example when two-dimensional scan is completed in the image processing apparatus;

FIG. 13 is a view illustrating a screen display example when a storage operation is started in the image processing apparatus;

FIG. 14 is a view illustrating a screen display example when three-dimensional scan is completed in the image processing apparatus;

FIG. 15 is a flowchart illustrating an operation example of the control device in the exemplary embodiment of the invention;

FIG. 16 is a flowchart illustrating an operation example of the control device when print processing is performed.

FIG. 17 is a flowchart illustrating an operation example of the control device when two-dimensional scan processing is performed;

FIG. 18 is a view illustrating a screen display example displayed in a first mode of the public print processing;

FIG. 19 is a view illustrating a screen display example displayed in a second mode of the public print processing;

FIG. 20 is a view illustrating a screen display example displayed in a third mode of the public print processing;

FIG. 21 is a view illustrating a screen display example displayed in a fourth mode of the public print processing;

FIG. 22 is a view illustrating a screen display example displayed in a fifth mode of the public print processing;

FIG. 23 is a flowchart illustrating an operation example of the control device when the public print processing is performed in the first to third modes;

FIG. 24 is a flowchart illustrating an operation example of the control device when the public print processing is performed in the fourth mode;

FIG. 25 is a flowchart illustrating an operation example of the control device when the public print processing is performed in the fifth mode; and

FIG. 26 is a flowchart illustrating an operation example of the control device when the public print processing is performed in the sixth and seventh modes.

### DETAILED DESCRIPTION

Hereinafter, an exemplary embodiment of the invention will be described in detail with reference to the accompanying drawings.

### [Entire Configuration of Image Processing Apparatus]

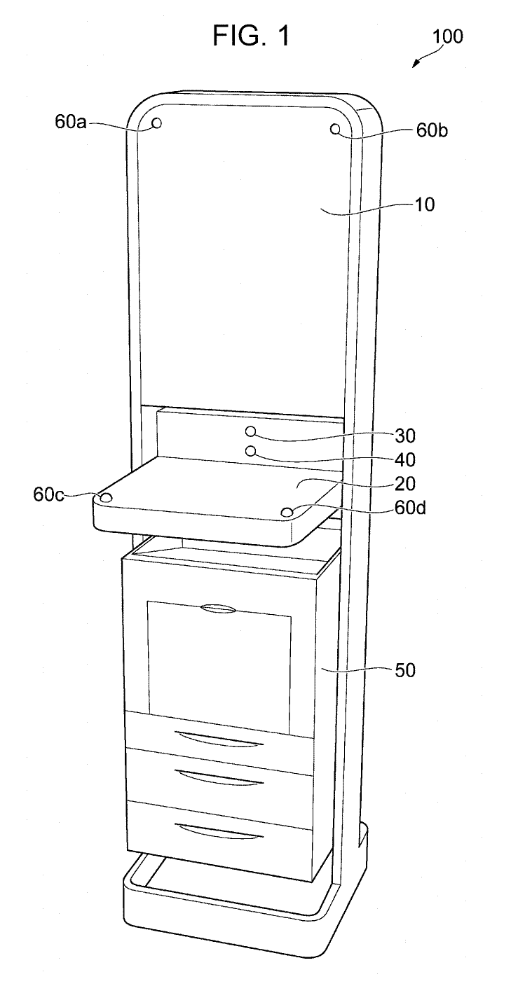

FIG. 1 is a perspective view of an image processing apparatus 100 according to an exemplary embodiment of the invention. As illustrated, the image processing apparatus 100 includes a guide display 10, an operation stand 20, a projector 30, an operation detector 40, a printer 50, and imagers 60a to 60d.

The guide display 10 is a display that displays a message to a user, such as guidance, for an operation of the image processing apparatus 100. Unlike the later-described operation stand 20, even when contact is made with the surface of the guide display 10, contact is not detected. Here, for instance, a liquid crystal display may be used as the guide display 10. In the exemplary embodiment, the guide display 10 is provided as an example of a first display surface that does not detect a contact operation.

The operation stand 20 is a substantially horizontal stand that projects toward a user so that the user can place and operate a mobile information terminal and a document. In this case, the “substantially horizontal” may refer to a horizontal levelness that does not cause a mobile information terminal or a document placed on the operation stand 20 to slip down. The operation stand 20 is designed so that an image is displayed by the function of the later-described projector 30, and contact with the surface of the operation stand 20 is detected by the function of the later-described operation detector 40. However, the operation stand 20 itself may be configurated by a display and a projector 30 may not be provided. In the exemplary embodiment, the operation stand 20 is provided as an example of a display surface, a second display surface, and a platen.

The projector 30 is a projector that projects an image onto the operation stand 20. The projector 30 projects an image onto the operation stand 20 in an oblique direction from above because the projector 30 is provided at a lower portion of the guide display 10. The projector 30, however, may be provided vertically above the operation stand 20 to project an image onto the operation stand 20 in a direction from immediately above. Alternatively, the projector 30 may be provided vertically below the operation stand 20, or the projector 30 may project an image onto the operation stand 20 in a direction from immediately below using a mirror along with the projector 30. Here, for instance, a liquid crystal projector may be used as the projector 30.

The operation detector 40 detects an operation by contacting with the surface of the operation stand 20. Detection of the operation may be made by sensing blocking of infrared rays by a finger of a user, the infrared rays radiating to the surface of the operation stand 20 radially. Specifically, for instance, an infrared LED and an infrared sensor may be used as the operation detector 40.

The printer 50 is a printer that prints an image on paper or other media. Here, for instance, an electrophotographic system that forms an image by transferring toner adhering to a photoconductor onto a recording medium, or an inkjet printer that discharges ink on a recording medium to form an image may be used as the printer 50. Alternatively, the printer 50 may be a printer that creates a printed material by pressing a block, to which ink is applied, against paper or other media. In the exemplary embodiment, the printer 50 is provided as an example of the printer.

The imagers 60a to 60d are cameras that capture an image of a document or a mobile information terminal placed on the operation stand 20. Among these, the imagers 60a, 60b are provided at an upper portion of the guide display 10, and thus mainly capture an image of a document or a mobile information terminal placed on the operation stand 20 from above. Also, the imagers 60c, 60d are provided on the near side of the guide display 10, and thus mainly capture an image in an oblique direction from below when a three-dimensional object is placed on the operation stand 20. Like this, the imagers 60a to 60d have different applications according to the positions provided, and hereinafter are referred to as the imager 60 when these imagers are not distinguished from each other. In this case, the imager 60 is provided as a scanner, thus hereinafter “captures something” may also be expressed as “scans something”. In the exemplary embodiment, the imager 60 is provided as an example of the reading device. Although four imagers 60 are illustrated in the drawings, the number of imagers 60 is not limited to four. For instance, an imager 60 for detecting a line of sight and/or motion of a user may be provided at a position which allows such detection.

### [Hardware Configuration of Image Processing Apparatus]

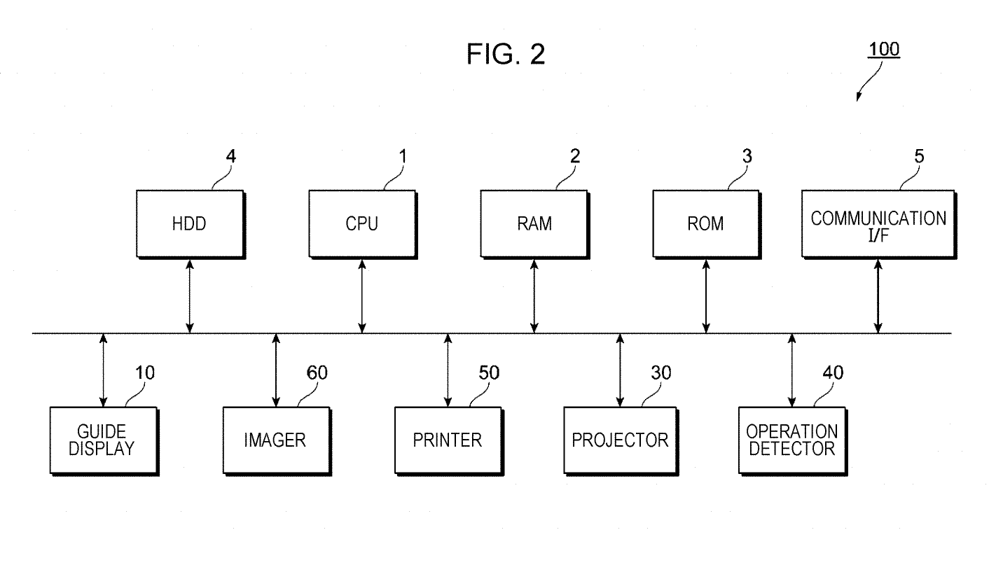

FIG. 2 is a diagram illustrating an example of a hardware configuration of the image processing apparatus 100 according to the exemplary embodiment. As illustrated, the image processing apparatus 100 includes a central processing unit (CPU) 1, a random access memory (RAM) 2, a read only memory (ROM) 3, a hard disk drive (HDD) 4, a communication interface (hereinafter referred to as a “communication I/F”) 5, a guide display 10, a projector 30, an operation detector 40, a printer 50, and an imager 60.

The CPU 1 implements the later-described functions by loading various programs stored in the ROM 3 into the RAM 2, and executing the programs. The RAM 2 is a memory that is used as a memory for work of the CPU 1. The ROM 3 is a memory that stores various programs to be executed by the CPU 1. The HDD 4 is, for instance, a magnetic disk device that stores data scanned by the imager 60, data used by printing in the printer 50 and other data. The communication I/F 5 transmits and receives various information to and from other devices via a communication line.

Since the guide display 10, the projector 30, the operation detector 40, the printer 50, and the imager 60 have been already described with reference to FIG. 1, a description thereof is omitted here.

### [Functional Configuration of Control Device]

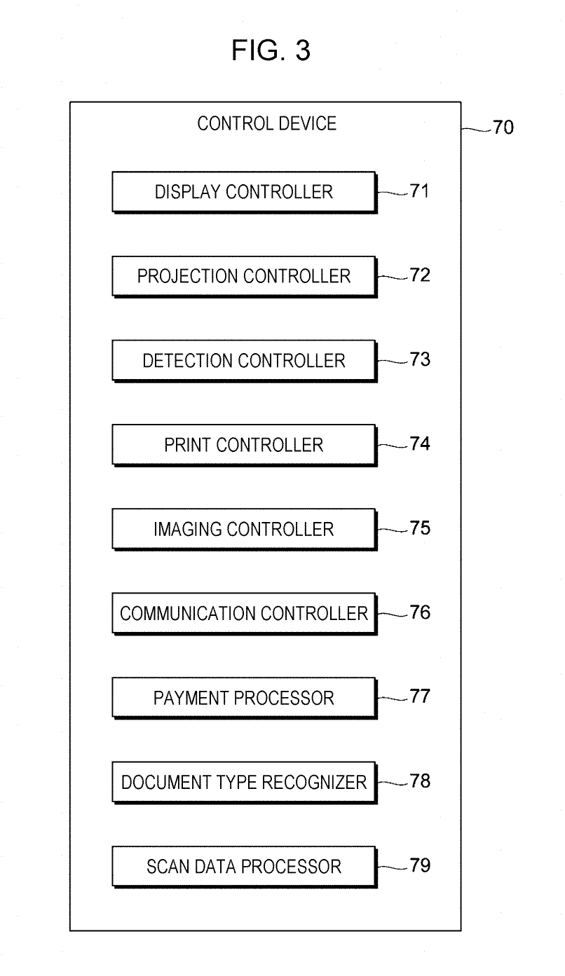

FIG. 3 is a block diagram illustrating a functional configuration example of a control device 70 that controls the image processing apparatus 100. Here, the control device 70 is an example of a display device and a an image reading device, and is regarded as a device which is implemented by the CPU 1 (see FIG. 2) of the image processing apparatus 100 in such a manner that the CPU 1 reads a program implementing the later-described functional units, for instance, from the ROM 3 (see FIG. 2) to the RAM 2 (see FIG. 2) and executes the program. As illustrated, the control device 70 includes a display controller 71, a projection controller 72, a detection controller 73, a print controller 74, an imaging controller 75, a communication controller 76, a payment processor 77, a document type recognizer 78, and a scan data processor 79.

The display controller 71 displays various types of guidance and various screens on the guide display 10. In the exemplary embodiment, the display controller 71 is provided as an example of a first display unit that displays information on the first display surface.

The projection controller 72 displays various screens on the operation stand 20 using the projector 30. In the exemplary embodiment, the projection controller 72 is provided as an example of a second display unit that displays information on the display surface, the second display surface, and the platen.

The detection controller 73 determines whether or not the operation detector 40 has detected an operation by contacting with the surface of the operation stand 20. In addition, the detection controller 73 also determines whether or not a human sensor (not illustrated) has detected approach of a user.

The print controller 74 controls printing by the printer 50.

The imaging controller 75 controls the imager 60 to capture an image of a document or a mobile information terminal placed on the operation stand 20, and obtains the image captured by the imager 60. In particular, the imaging controller 75 controls the imager 60 such that when a predetermined time has elapsed since a document is placed on the operation stand 20, the imager 60 scans the document. In the exemplary embodiment, the imaging controller 75 is provided as an example of a reading unit that reads an image. Also, the imaging controller 75 may obtain a detection result from the imager 60 that detects a line of sight and/or motion of a user. In this case, the imaging controller 75 is an example of a detection unit that detects motion of a user.

When information recorded on a card is read by a card reader (not illustrated), the communication controller 76 receives the information from the card reader. Also, when information stored in a mobile information terminal is received by a near field communication (NFC) reader (not illustrated), the communication controller 76 receives the information from the NFC reader. In addition, the communication controller 76 receives information stored in a mobile information terminal via Wi-Fi (registered trademark). Instead of Wi-Fi, Bluetooth (registered trademark) may be used. However, a description is given below with Wi-Fi used. In the exemplary embodiment, the communication controller 76 is provided as an example of a reading unit that reads information.

In addition, the communication controller 76 receives a file from an external cloud system or transmits a file to an external cloud system via the communication I/F 5. In the exemplary embodiment, the communication controller 76 is provided as an example of a receiving unit that receives data from another device, and an example of a transmission unit that transmits data to another device.

The payment processor 77 performs payment-related processing such as generation of payment information based on the information received by the communication controller 76 from the card reader and the information received by the communication controller 76 from Wi-Fi.

When a document is placed on the operation stand 20, the document type recognizer 78 recognizes the type of the document. The type of the document may be recognized, for instance, by pattern matching with image data pre-stored for each type of document.

The scan data processor 79 performs various types of processing on scan data obtained by the imaging controller 75. Here, the various types of processing include processing of scan data, and processing to integrate pieces of scan data obtained by multiple scans. In the exemplary embodiment, the scan data processor 79 is provided as an example of an output unit that outputs an image obtained by integrating two images.

### [Screen Display Example of Image Processing Apparatus]

In the exemplary embodiment, final printing and scanning are performed by the image processing apparatus 100, but a prior operation for the printing and scanning is performed by a mobile information terminal such as a smartphone.

Thus, before a screen display example of the image processing apparatus 100 is described, a prior operation performed in the mobile information terminal will be described. An application software (hereinafter referred to as an “application”) for utilizing the image processing apparatus 100 is installed in the mobile information terminal, and a user performs the prior operation using the application. It is to be noted that the application used in the exemplary embodiment is only for utilizing the image processing apparatus 100, thus any “application” mentioned in the present description indicates the application for utilizing the image processing apparatus 100.

First, the operation for the first time in the mobile information terminal will be described. When subscribing a service for utilizing the image processing apparatus 100, a user starts up the application by the mobile information terminal, and registers authentication information and other various information for performing authentication in the mobile information terminal.

The various information (hereinafter referred to as “registration information”) registered in the mobile information terminal includes a payment method, a print setting, and a storage destination.

In the exemplary embodiment, the image processing apparatus 100 is designed to be installed and utilized in a public space, and thus a payment method has to be registered. Specifically, the payment method indicates how payment is made for printing and scanning, and includes, for instance, payment by a credit card, and payment by an electronic money IC card.

Also, the print setting indicates a desired print style when printing is made. In addition to normal print setting such as monochrome printing or color printing, and single-sided printing or double-sided printing, the print setting also includes a special output style such as stapling, and putting a printed material in an envelope or a vinyl bag.

Also, the storage destination indicates where scan data obtained by scanning a document is stored. The storage destination includes an expense settlement cloud system, a document management cloud system, and a business card management cloud system. These storage destinations may be each registered as the location where scan data of a document is stored according to the type of the document. Registration may be made such that for instance, when the type of a document is receipt, the scan data is stored in the expense settlement cloud system, when the type of a document is A4 paper, the scan data is stored in the document management cloud system, and when the type of a document is business card, the scan data is stored in the business card cloud system.

Next, the operation for the second time and after in the mobile information terminal will be described. For instance, when printing a file stored in a cloud system, a user starts up the application by the mobile information terminal, obtains a list of files from the cloud system, and the list is displayed on the display of the mobile information terminal. In this state, a user reserves printing by designating a file which is desired to be printed. Hereinafter, a file for which printing is reserved is called a “print reservation file”. Also, a user registers various information in the print reservation file. For instance, a user sets an output format, and a payment method to the print reservation file. Alternatively, a user may leave the output format and the payment method unset.

Subsequently, for actually printing the file, a user has to go to an installation location of the image processing apparatus 100 in a public space. The application of the mobile information terminal also provides relevant information for this case. For instance, when a user designates a print reservation file and presses down a search button of the mobile information terminal, the application displays a map of the surrounding area of the user on the display of the mobile information terminal, and displays the installation location of an image processing apparatus 100 that can print the print reservation file in consideration of an output format set for the designated print reservation file. Thus, it is possible for the user to go to the installation location of the image processing apparatus 100 and to print the print reservation file which is desired to be printed.

Hereinafter, a screen display example in the image processing apparatus 100 will be described.

(Screen Display Example during Stand-by)

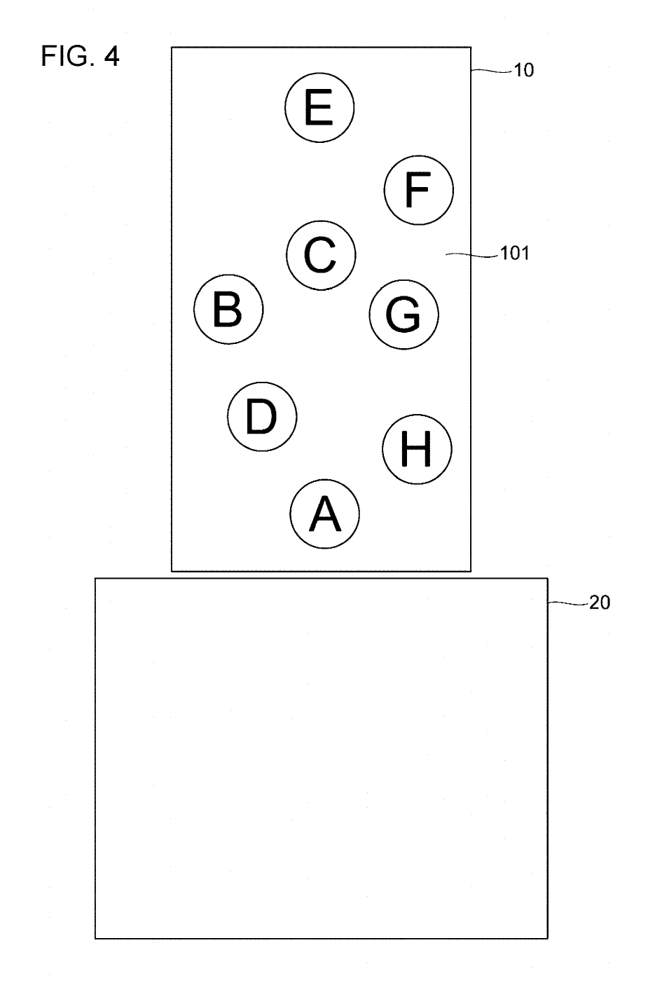

FIG. 4 is a view illustrating a screen display example during stand-by of the image processing apparatus 100. As illustrated, the image processing apparatus 100 displays a stand-by screen 101 on the guide display 10 during stand-by. The stand-by screen 101 includes a graphic as an example of a display element that expresses information which is considered to be necessary for a user related to the installation location of the image processing apparatus 100. FIG. 4 illustrates information A to H as an example of such information. The stand-by screen 101 has various versions according to the installation location of the image processing apparatus 100, and the information A to H vary with the version of the stand-by screen 101. For instance, when the image processing apparatus 100 is installed in a station, the stand-by screen 101 is a station version, and the information A to H is the information on train operation, schedule, and travel. Although all graphics indicating the information A to H have the same size in FIG. 4, the size may be changed according to a priority level of information, for instance, a graphic indicating information that is considered to be highly necessary for users is displayed in large size.

In the state where the stand-by screen 101 of FIG. 4 is displayed, when one of a mobile information terminal 90, a document 95, and a three-dimensional object 97 is placed on the operation stand 20 by a user, the image processing apparatus 100 proceeds to one of print processing, two-dimensional scan processing, and three-dimensional scan processing according to the object placed on the operation stand 20. Specifically, when the mobile information terminal 90 is placed on the operation stand 20 by a user, successful authentication based on authentication information transmitted by the application which has been started up in the mobile information terminal 90 causes the image processing apparatus 100 to proceed to the print processing. In contrast, when the document 95 is placed on the operation stand 20 by a user, the image processing apparatus 100 proceeds to the two-dimensional scan processing, and when the three-dimensional object 97 is placed on the operation stand 20 by a user, the image processing apparatus 100 proceeds to the three-dimensional scan processing.

### (Screen Display Example at Time of Print Processing)

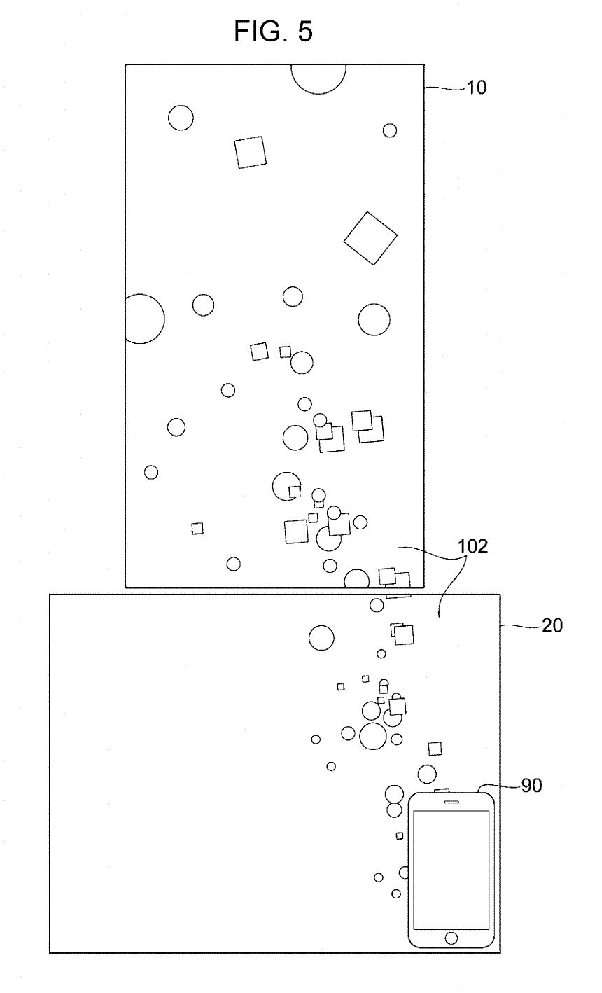

FIG. 5 is a view illustrating a screen display example when login is completed in the image processing apparatus 100. When the mobile information terminal 90 is placed on the operation stand 20 by a user and authentication is successful, the image processing apparatus 100 starts print processing. In this process, successful authentication causes login processing to be completed, thus the image processing apparatus 100 first displays a login completion screen 102 on the guide display 10 and the operation stand 20. As illustrated, the login completion screen 102 is a screen in which the mobile information terminal 90, the operation stand 20, and the guide display 10 are linked by animation.

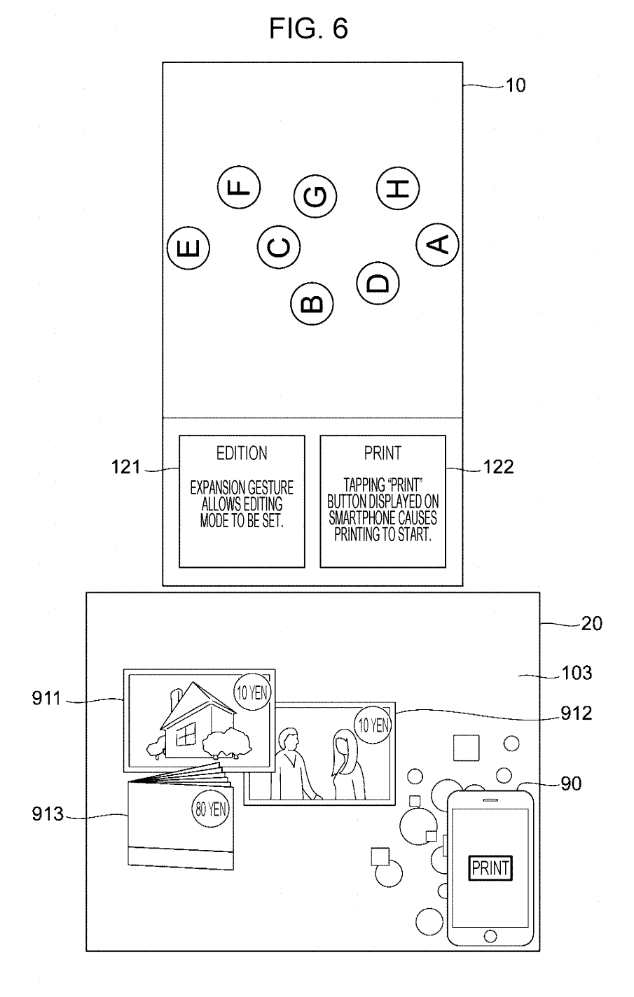

FIG. 6 is a view illustrating a screen display example when a print operation is started in the image processing apparatus 100. When a print reservation file is designated by the mobile information terminal 90 placed on the operation stand 20, the image processing apparatus 100 displays a print instruction screen 103 on the operation stand 20. The print instruction screen 103 includes an image (hereinafter referred to as a “file image”) indicating the print reservation file. FIG. 6 illustrates file images 911 to 913 as an example of such a file image. Furthermore, in FIG. 6, a printing fee is calculated according to the attribute of the print reservation file, and the printing fee is also displayed on the print instruction screen 103. On the other hand, the image processing apparatus 100 displays a guide 121 regarding edition and a guide 122 regarding print on the guide display 10. At this point, as illustrated, the application displays a print button on the display of the mobile information terminal 90.

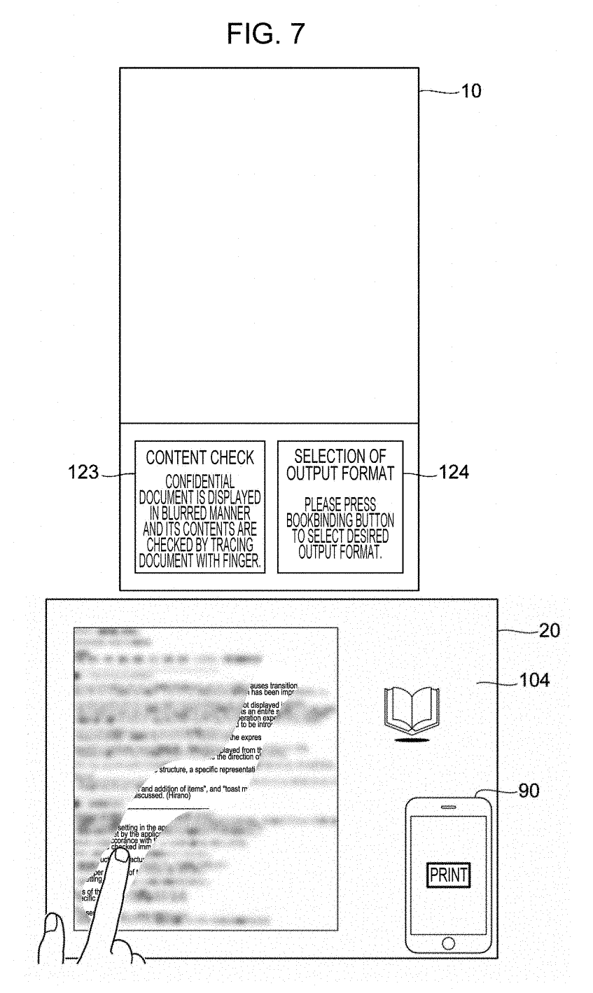

FIG. 7 is a view illustrating a screen display example when file contents are checked in the image processing apparatus 100. When an expansion gesture is made by a user in accordance with the guide 121 of FIG. 6, the image processing apparatus 100 displays a file content display screen 104 on the operation stand 20. The file content display screen 104 is a screen that displays a document in actual size and allows editing of the document. For instance, when an expansion gesture is made on the file image 913, the contents of the print reservation file represented by the file image 913 are displayed. On the other hand, the image processing apparatus 100 displays a guide 123 regarding content check and a guide 124 regarding an output format. The characters of a confidential document such as an in-house document are first displayed in a blurred manner, and the characters traced by a finger of a user in accordance with the guide 123 may be displayed in a recognizable manner. Alternatively, the characters traced by the palm of a user may be displayed in a more recognizable manner.

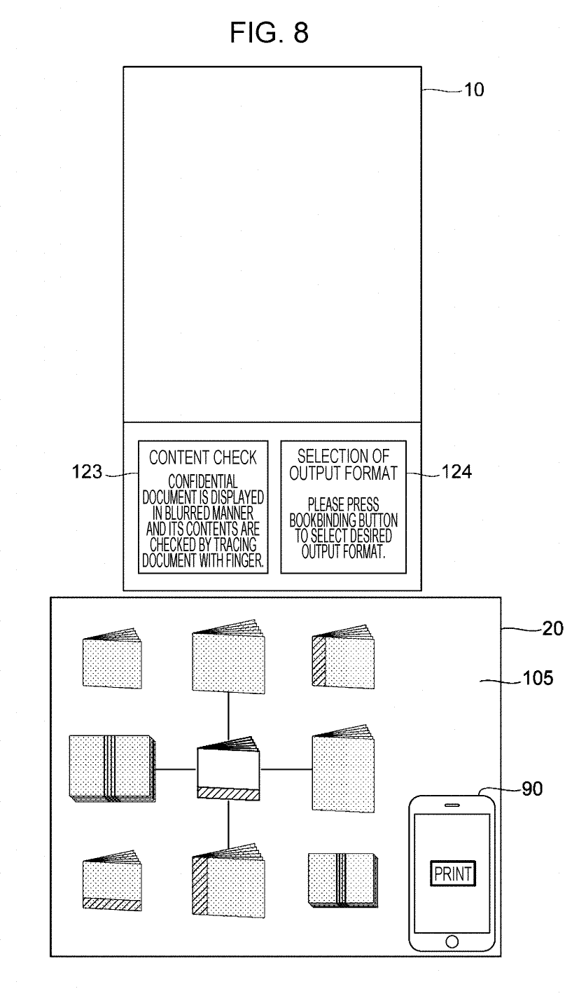

FIG. 8 is a view illustrating a screen display example when an output format is selected in the image processing apparatus 100. When a bookbinding button (not illustrated) is pressed down by a user in accordance with the guide 124 of FIG. 7, the image processing apparatus 100 displays an output format display screen 105 on the operation stand 20. The output format display screen 105 includes various output formats, and a desired output format is selectable from the output formats. When one of the output formats is selected by a user, the image processing apparatus 100 returns the current screen to the original screen.

Subsequently, in the state where the print instruction screen 103 of FIG. 6 is displayed, when a printing fee is paid and the print button is pressed down by a user, the image processing apparatus 100 starts printing. In this process, the image processing apparatus 100 moves the file images 911 to 913 toward the near side to fade out of sight.

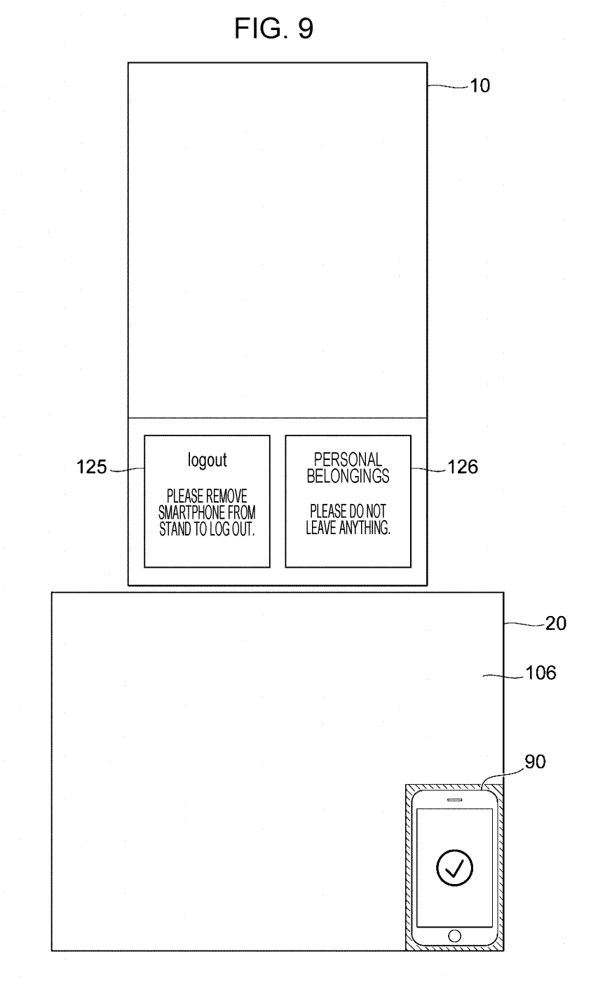

FIG. 9 is a view illustrating a screen display example when a print operation is completed in the image processing apparatus 100. When the print operation is completed, the image processing apparatus 100 displays a logout guide screen 106 on the operation stand 20. The logout guide screen 106 includes a faintly shining area around the mobile information terminal 90 for prompting a user to remove the mobile information terminal 90. On the other hand, the image processing apparatus 100 displays a guide 125 regarding logout and a guide 126 regarding personal belongings on the guide display 10. At this point, as illustrated, the application displays a check mark on the display of the mobile information terminal 90 to notify a user of completion of printing.

Thus, when a user removes the mobile information terminal 90 from the operation stand 20, the image processing apparatus 100 performs logout processing, and displays a message indicating completion of logout on the guide display 10 and the operation stand 20. Also, the application displays a message indicating completion of logout on the display of the mobile information terminal 90.

### (Screen Display Example at Time of Two-dimensional Scan Processing)

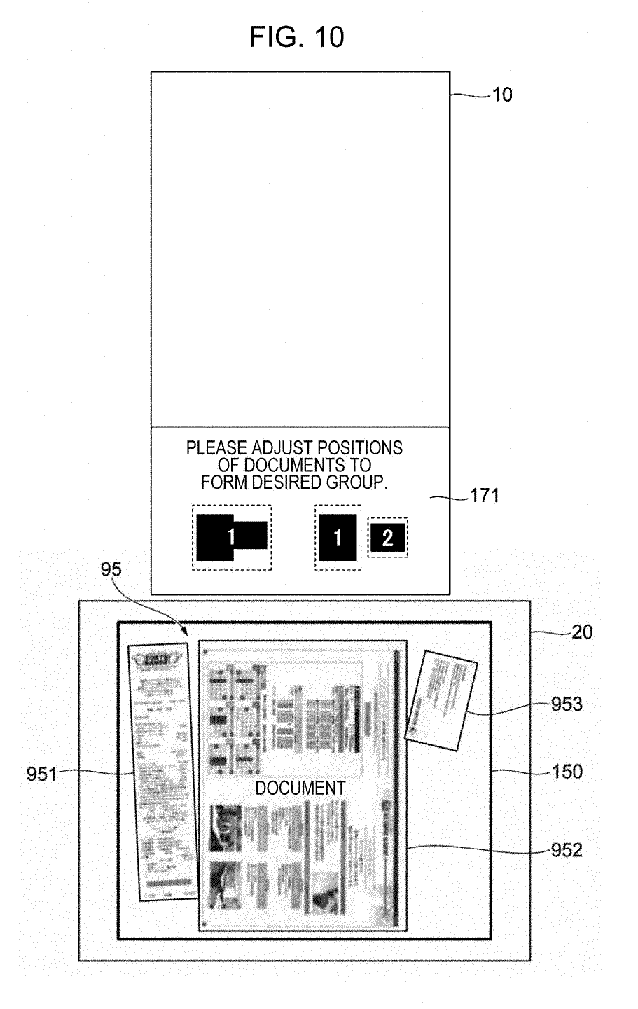

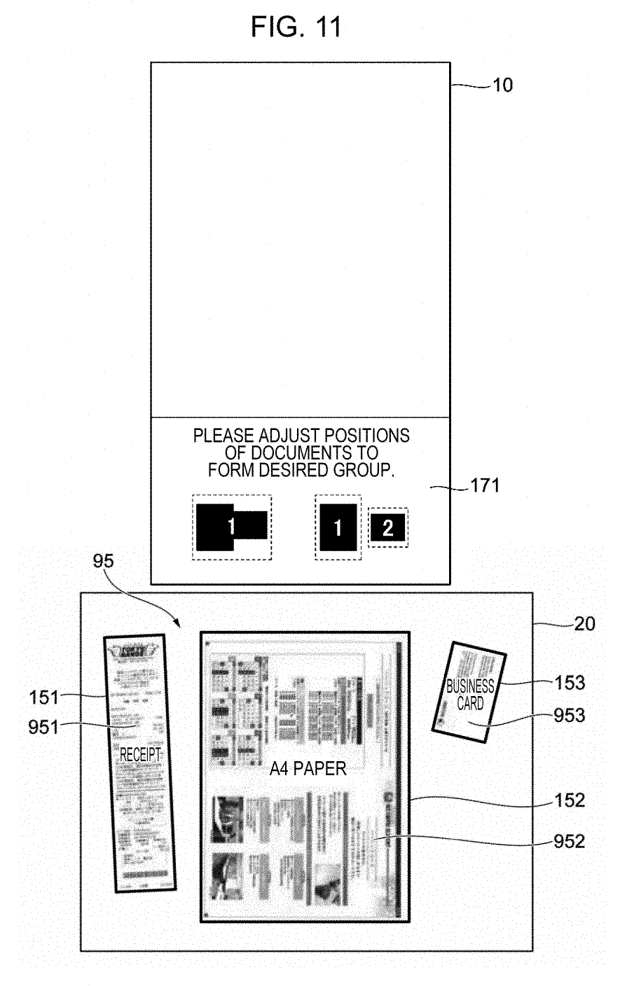

FIGS. 10 and 11 are each a view illustrating a screen display example when the document 95 is placed on the operation stand 20 by a user. When the document 95 is placed on the operation stand 20 by a user, the image processing apparatus 100 displays a guide 171 regarding position adjustment of the document 95 on the guide display 10. First, a case is considered where a receipt 951, an A4 paper 952, and a business card 953 are placed as the document 95 closely to each other on the operation stand 20 by a user in accordance with the guide 171 as illustrated in FIG. 10. In this case, the image processing apparatus 100 recognizes the type of the document 95 as a document, and displays a document type recognition result 150 indicating the type on the operation stand 20. Next, a case is considered where the receipt 951, the A4 paper 952, and the business card 953 are placed as the document 95 apart from each other on the operation stand 20 by a user in accordance with the guide 171 as illustrated in FIG. 11. In this case, the image processing apparatus 100 recognizes the types of the document 95 as a receipt, A4 paper, and a business card, and displays document type recognition results 151 to 153 indicating the types on the operation stand 20.

Subsequently, when a predetermined time elapses with the document 95 placed as illustrated in FIG. 11, the image processing apparatus 100 scans the document 95.

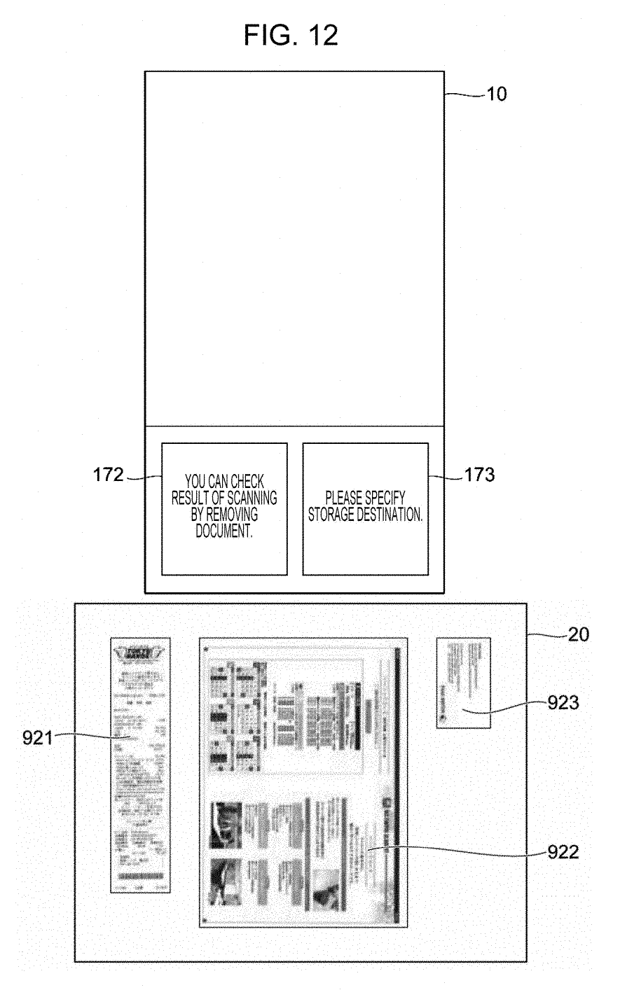

FIG. 12 is a view illustrating a screen display example when the scan is completed in the image processing apparatus 100. When the scan is completed, the image processing apparatus 100 displays a guide 172 regarding removal of the document 95 and a guide 173 regarding storage destination on the guide display 10. When the receipt 951, the A4 paper 952, and the business card 953 are removed from the operation stand 20 by a user in accordance with the guide 172, the image processing apparatus 100 displays a scanned image 921 of the receipt, a scanned image 922 of the A4 paper, and a scanned image 923 of the business card on the operation stand 20. In this process, the image processing apparatus 100 displays the scanned images 921 to 923 in an erect state.

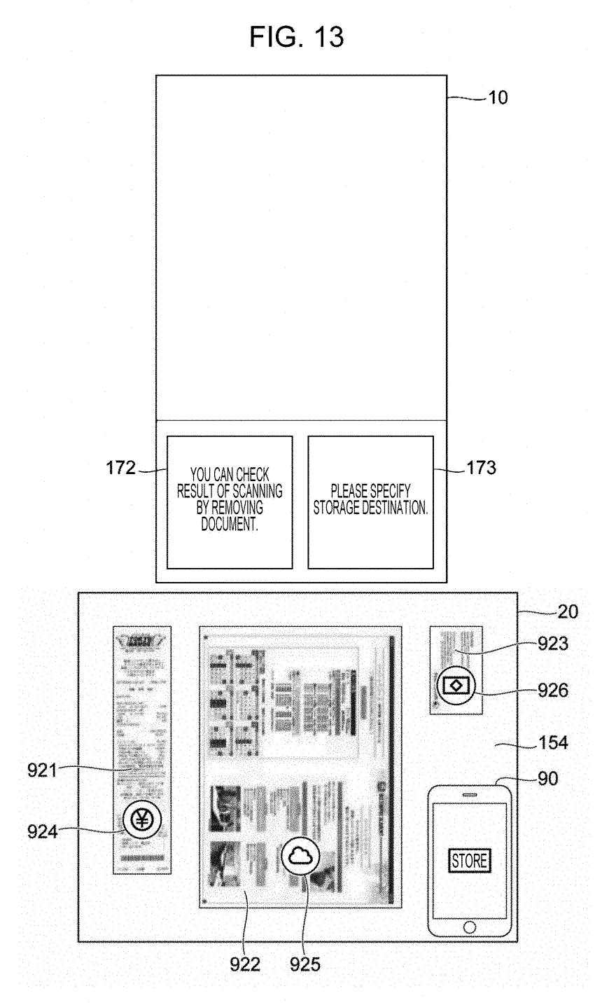

FIG. 13 is a view illustrating a screen display example when a storage operation is started in the image processing apparatus 100. When the mobile information terminal 90 is placed on the operation stand 20 by a user, the image processing apparatus 100 displays a storage instruction screen 154 on the operation stand 20. In addition to the scanned images 921 to 923, the storage instruction screen 154 includes storage destination icons 924 to 926 indicating respective storage destinations registered for the types of document in the mobile information terminal 90. Here, the storage destination icon 924 indicates the expense settlement cloud system registered as the storage destination of scan data of receipt. Also, the storage destination icon 925 indicates the document management cloud system registered as the storage destination of scan data of A4 paper. In addition, the storage destination icon 926 indicates the business card management cloud system registered as the storage destination of scan data of business card. In this process, the application displays a storage button on the display of the mobile information terminal 90. When a storage fee is paid and the storage button is pressed down on the storage instruction screen 154 by a user, the image processing apparatus 100 stores the scan data of the receipt, A4 paper, and business card in the respective corresponding cloud systems.

Subsequently, as illustrated in FIG. 9, the image processing apparatus 100 displays the guide 125 regarding logout, and the guide 126 regarding personal belongings on the guide display 10. Thus, when a user removes the mobile information terminal 90 from the operation stand 20, the image processing apparatus 100 performs logout processing, and displays a message indicating completion of logout on the guide display 10 and the operation stand 20. Also, the application displays a message indicating completion of logout on the mobile information terminal 90.

### (Screen Display Example at Time of Three-dimensional Scan Processing)

When a predetermined time elapses with the three-dimensional object 97 placed on the operation stand 20, the image processing apparatus 100 scans the three-dimensional object 97. When the three-dimensional object 97 is removed from the operation stand 20 by a user, the image processing apparatus 100 displays a result of scanning the three-dimensional object 97 on the guide display 10 and the operation stand 20.

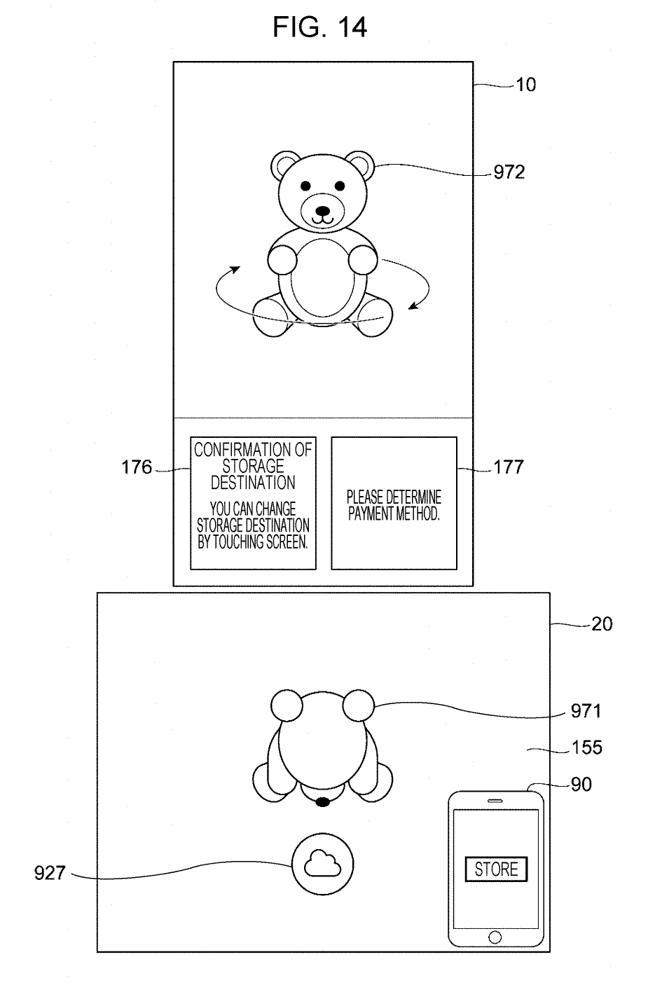

FIG. 14 is a view illustrating a screen display example when the scan is completed in the image processing apparatus 100. When the scan is completed, the image processing apparatus 100 displays a planar image 971 of a scan result on the operation stand 20. On the other hand, the image processing apparatus 100 displays a three-dimensional image 972 of a scan result on the guide display 10. The three-dimensional image 972 is displayed while being rotated as indicated by an arrow in FIG. 14, thereby allowing a user to check the three-dimensional shape of the scan result. In addition, the image processing apparatus 100 displays a guide 176 regarding confirmation of a storage destination and a guide 177 regarding determination of a payment method on the guide display 10. When the mobile information terminal 90 is placed on the operation stand 20 by a user in this state, the image processing apparatus 100 displays a storage instruction screen 155 on the operation stand 20. In addition to the planar image 971 of the scan result, the storage instruction screen 155 includes a storage destination icon 927 indicating a storage destination registered in the mobile information terminal 90. Here, the storage destination icon 927 indicates a cloud system which is registered as the storage destination of scan data of three-dimensional objects. In this process, the application displays a storage button on the display of the mobile information terminal 90. When a storage fee is paid and the storage button is pressed down on the storage instruction screen 155 by a user, the image processing apparatus 100 stores the scan data of the three-dimensional object 97 in a corresponding cloud system.

Subsequently, as illustrated in FIG. 9, the image processing apparatus 100 displays the guide 125 regarding logout, and the guide 126 regarding personal belongings on the guide display 10. Thus, when the mobile information terminal 90 is removed from the operation stand 20 by a user, the image processing apparatus 100 performs logout processing, and displays a message indicating completion of logout on the guide display 10 and the operation stand 20. Also, the application displays a message indicating completion of logout on the mobile information terminal 90.

### [Operation Example of Control Device]

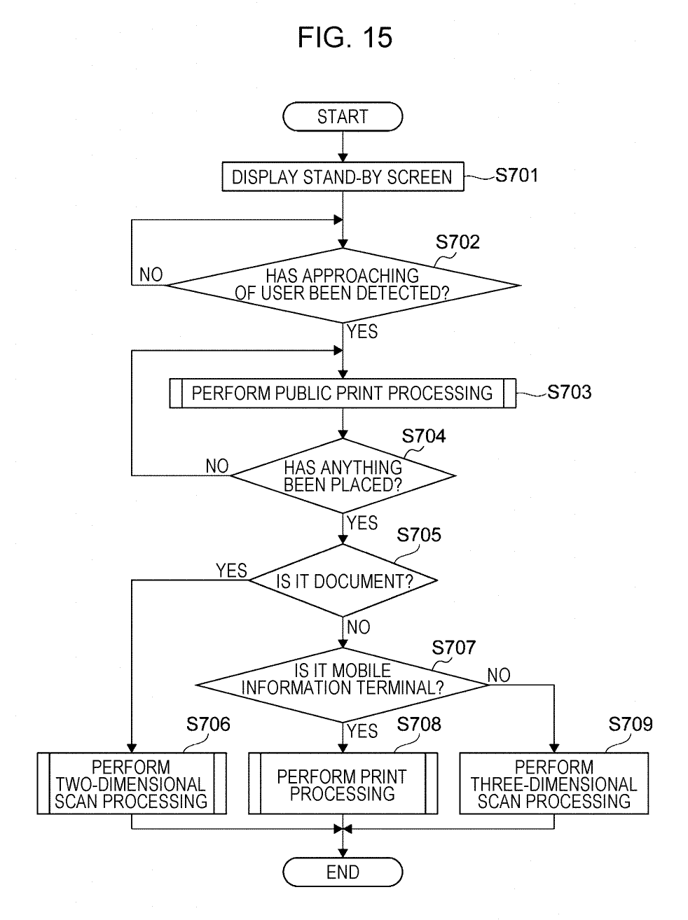

FIG. 15 is a flowchart illustrating an operation example of the control device 70 that performs such screen display.

As illustrated, in the control device 70, the display controller 71 first displays the stand-by screen 101 on the guide display 10 (step 701).

Next, the detection controller 73 determines whether or not a human sensor has detected approach of a user (step 702). When it is determined that the human sensor has not detected approach of a user, the detection controller 73 repeats step 702, whereas when it is determined that the human sensor has detected approach of a user, the control device 70 performs public print processing to print information necessary for a user in a public space (step 703).

Subsequently, the imaging controller 75 determines whether or not the imager 60 has detected anything placed on the operation stand 20 (step 704). When it is determined that the imager 60 has not detected anything placed on the operation stand 20, the control device 70 continues the public print processing.

On the other hand, when it is determined that the imager 60 has detected anything placed on the operation stand 20, the imaging controller 75 determines whether or not the imager 60 has detected the document 95 placed on the operation stand 20 (step 705). As a result, when it is determined that the imager 60 has detected the document 95 placed on the operation stand 20, the control device 70 performs two-dimensional scan processing (step 706).

Also, when it is determined that the imager 60 has not detected the document 95 placed on the operation stand 20, the imaging controller 75 determines whether or not the imager 60 has detected the mobile information terminal 90 placed on the operation stand 20 (step 707). As a result, when it is determined that the imager 60 has detected the mobile information terminal 90 placed on the operation stand 20, the control device 70 performs print processing (step 708). At this point, in the control device 70, it is assumed that the communication controller 76 obtains authentication information registered in the mobile information terminal 90 before the print processing is performed, makes authentication and Wi-Fi connection setting based on the authentication information, and receives registration information from the mobile information terminal 90 via Wi-Fi. On the other hand, when it is determined that the imager 60 has not detected the mobile information terminal 90 placed on the operation stand 20, the control device 70 performs three-dimensional scan processing (step 709).

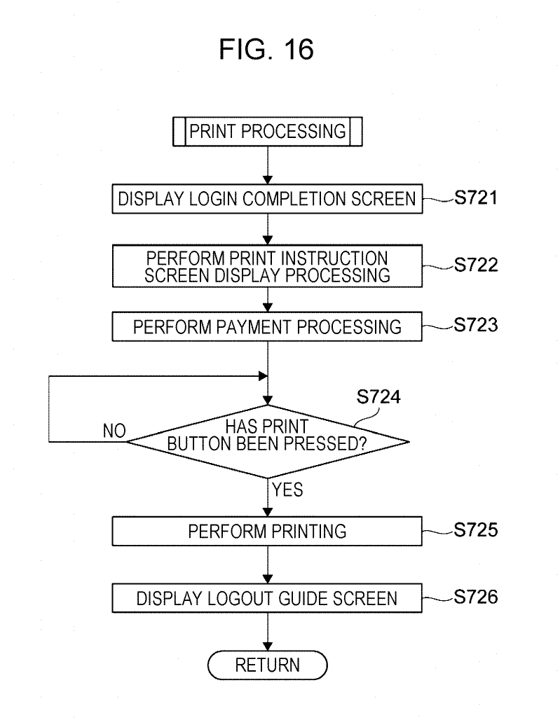

FIG. 16 is a flowchart illustrating an operation example of the control device 70 when the print processing in step 708 of FIG. 15 is performed.

As illustrated, the control device 70 first displays the login completion screen 102 on the guide display 10 and the operation stand 20 (step 721). Specifically, the display controller 71 displays part of the login completion screen 102 on the guide display 10, and the projection controller 72 displays the remaining part of the login completion screen 102 on the operation stand 20 using the projector 30.

Next, the projection controller 72 performs print instruction screen display processing to display a print instruction screen 103 on the operation stand 20 using the projector 30, the print instruction screen 103 for giving an instruction to print a print reservation file (step 722).

Subsequently, the payment processor 77 performs payment processing by a payment method registered for the print reservation file in the registration information or a payment method selected then (step 723). The communication controller 76 then determines whether or not notification that the print button has been pressed down in the mobile information terminal 90 has been received via Wi-Fi (step 724). When it is determined that notification that the print button has been pressed down in the mobile information terminal 90 has not been received via Wi-Fi, the communication controller 76 repeats step 724, whereas when it is determined that notification that the print button has been pressed down in the mobile information terminal 90 has been received via Wi-Fi, the print controller 74 performs control so that printing is made by the printer 50 (step 725).

Subsequently, when printing by the printer 50 is completed, the projection controller 72 displays the logout guide screen 106 on the operation stand 20 using the projector 30 (step 726).

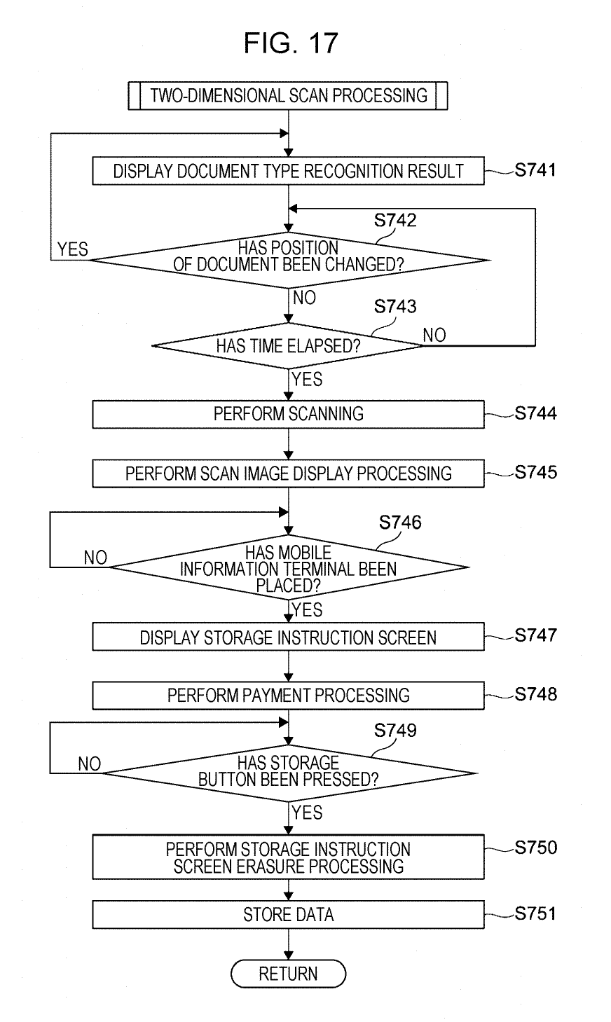

FIG. 17 is a flowchart illustrating an operation example of the control device 70 when the two-dimensional scan processing in step 706 of FIG. 15 is performed.

As illustrated, the control device 70 first displays a document type recognition result on the operation stand 20 (step 741). Specifically, the imaging controller 75 obtains the image of the document 95 captured by the imager 60, the document type recognizer 78 recognizes the type of the document 95, for instance, by pattern matching, and the projection controller 72 displays a result of the recognition on the operation stand 20 using the projector 30.

Next, the imaging controller 75 determines whether or not the imager 60 has detected change in the position of the document 95 (step 742). When it is determined that the imager 60 has detected change in the position of the document 95, the control device 70 performs step 741 again. When it is determined that the imager 60 has not detected change in the position of the document 95, the imaging controller 75 determines whether or not a predetermined time has elapsed (step 743). When it is determined that a predetermined time has not elapsed, the imaging controller 75 performs step 742 again.

On the other hand, when it is determined that a predetermined time has elapsed, the imaging controller 75 scans the document 95 placed on the operation stand 20 using the imager 60 (step 744). Thus, the projection controller 72 performs scan image display processing to display the scanned image 92 on the operation stand 20 using the projector 30 (step 745).

Next, the imaging controller 75 determines whether or not the imager 60 has detected the mobile information terminal 90 placed on the operation stand 20 (step 746). When it is determined that the imager 60 has not detected the mobile information terminal 90 placed on the operation stand 20, the imaging controller 75 repeats step 746, whereas when it is determined that the imager 60 has detected the mobile information terminal 90 placed on the operation stand 20, the projection controller 72 displays a storage instruction screen on the operation stand 20 using the projector 30, the storage instruction screen for giving an instruction to store scan data (step 747). At this point, it is assumed that the communication controller 76 obtains authentication information registered in the mobile information terminal 90, makes authentication and Wi-Fi connection setting based on the authentication information, and receives registration information from the mobile information terminal 90 via Wi-Fi.

Subsequently, the payment processor 77 performs payment processing by a payment method registered for the type of the document 95 in the registration information or a payment method selected then (step 748). The communication controller 76 then determines whether or not notification that the storage button has been pressed down in the mobile information terminal 90 has been received via Wi-Fi (step 749). When it is determined that notification that the storage button has been pressed down in the mobile information terminal 90 has not been received via Wi-Fi, the communication controller 76 repeats step 749, whereas when it is determined that notification that the storage button has been pressed down in the mobile information terminal 90 has been received via Wi-Fi, the projection controller 72 performs storage instruction screen erasure processing to erase the storage instruction screen 154 (step 750). The communication controller 76 then transmits the scan data of the document 95 to a storage destination registered for the type of the document 95 via the communication I/F 5, and stores the scan data (step 751).

### [Screen Display Example of Image Processing Apparatus at Time of Public Print Processing]

In the exemplary embodiment, the screen displayed by the public print processing in step 703 of FIG. 15 is roughly divided into two types: one is for displaying on the operation stand 20 a graphic selected by an operation performed on the surface of the operation stand 20 from the graphics representing the information A to H displayed on the guide display 10, and the other is for displaying on the operation stand 20 a graphic selected by an operation of a user from the graphics representing the information A to H displayed on the guide display 10.

Between these, the former includes the type in which the graphics displayed on the guide display 10 is allowed to extend into the operation stand 20 and a graphic is selected by an operation on the operation stand 20. This type includes a mode (hereinafter referred to as a “first mode”) in which of the graphics displayed on the guide display 10, a graphic displayed on the side near the operation stand 20 is allowed to extend into the operation stand 20; and a mode (hereinafter referred to as a “second mode”) in which of the graphics displayed on the guide display 10, a graphic selected by an operation in an area into which a graphic extends is allowed to extend into the operation stand 20; a mode (hereinafter referred to as a “third mode”) in which of the graphics displayed on the guide display 10, a graphic selected by an operation in an area other than the area into which a graphic extends is allowed to extend into the operation stand 20; and a mode (hereinafter referred to as a “fourth mode”) in which of the graphics displayed on the guide display 10, a graphic selected without an operation of a user is allowed to extend into the operation stand 20. It is to be noted that the second and third modes may be regarded as a mode in which of the graphics displayed on the guide display 10, a graphic selected by an operation on the operation stand 20 is allowed to extend into the operation stand 20.

Also, the former includes a mode (hereinafter referred to as a “fifth mode”) in which one of the graphics displayed on the guide display 10 is selected by an operation on the operation stand 20 with the graphics not extending into the operation stand 20.

On the other hand, the latter includes a mode (hereinafter referred to as a “sixth mode”) in which of the graphics representing the information A to H displayed on the guide display 10, a graphic displayed at a position indicated by an operation of a user is displayed on the operation stand 20; and a mode (hereinafter referred to as a “seventh mode”) in which of the graphics representing the information A to H displayed on the guide display 10, a graphic corresponding to identification information indicated by an operation of a user is displayed on the operation stand 20.

Hereinafter, the first to seventh modes of the public print processing will be specifically described.

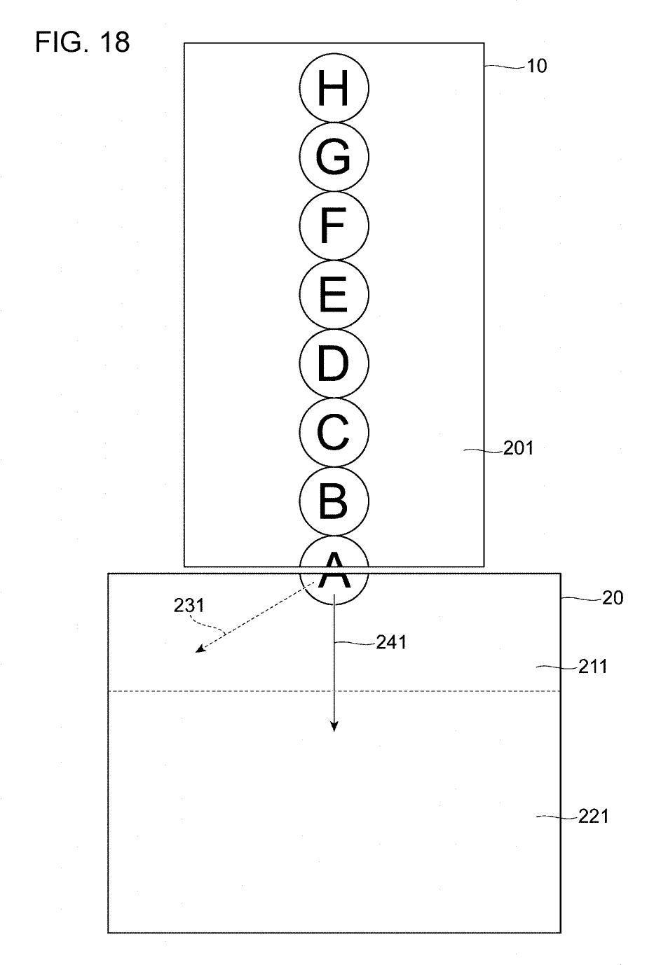

FIG. 18 is a view illustrating a screen display example displayed in the first mode of the public print processing in step 703 of FIG. 15. When a user approaches the image processing apparatus 100 with the stand-by screen 101 displayed, the image processing apparatus 100 displays on the guide display 10 a public print screen 201 in which the graphics representing the information A to H are aligned in a vertical row. At this point, the image processing apparatus 100 displays part of a graphic that represents the lowermost information A in a selection candidate display area 211 which is an example of a first area of the operation stand 20. In this state, when a user touches a graphic representing the information A in the selection candidate display area 211 to perform a swipe operation in the direction indicated by a dashed line arrow 231, on the public print screen 201, the graphics representing the information B to H slide down to respective positions at which the graphics representing the information A to G are used to be, and the graphic representing the information A is moved to the position at which the graphic representing the information H is used to be. During the operation to move the graphics representing the information A to H in this manner, when a graphic representing desired information appears in the selection candidate display area 211, a swipe operation performed by a user on the graphic representing the desired information in the direction indicated by a solid line arrow 241 causes the image processing apparatus 100 to display the graphic in a print target display area 221, the swipe operation being an example of a first operation, the print target display area 221 being an example of a second area of the operation stand 20.

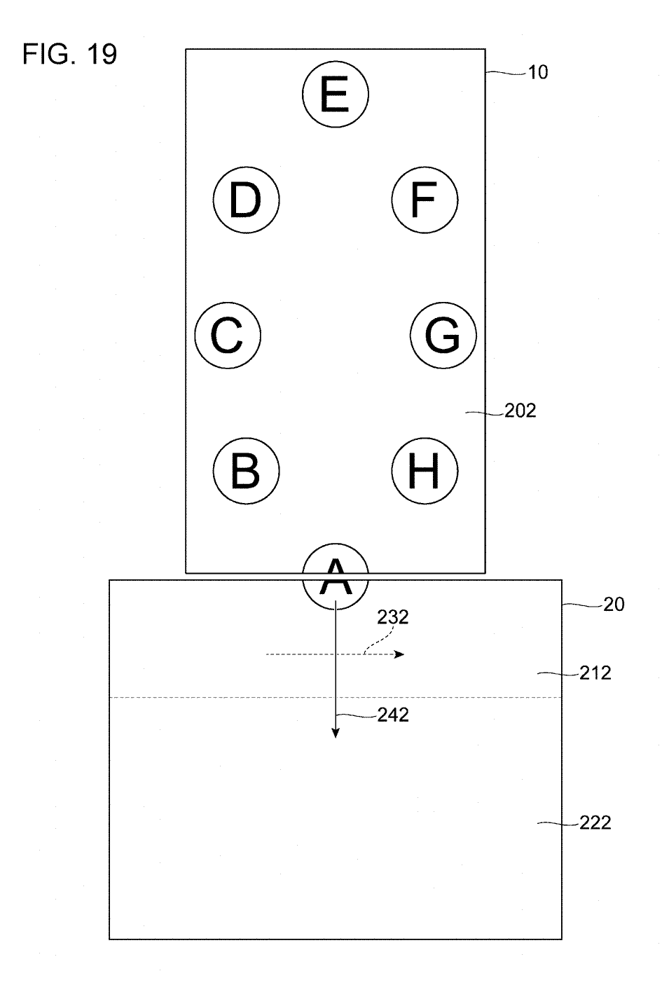

FIG. 19 is a view illustrating a screen display example displayed in the second mode of the public print processing in step 703 of FIG. 15. When a user approaches the image processing apparatus 100 with the stand-by screen 101 of FIG. 4 displayed, the image processing apparatus 100 displays on the guide display 10 a public print screen 202 in which the graphics representing the information A to H are aligned in a circular manner. At this point, the image processing apparatus 100 displays part of a graphic that represents the lowermost information A in a selection candidate display area 212 which is an example of the first area of the operation stand 20. In this state, when a user touches the selection candidate display area 212 to perform a swipe operation in the direction indicated by a dashed line arrow 232, a circle including the graphics representing the information A to H rotates in the counterclockwise direction on the public print screen 202, the swipe operation being an example of a second operation. In other words, the graphic representing the information A is moved to the position at which the graphic representing the information H is used to be, and the graphics representing the information B to H are moved to the respective positions at which the graphics representing the information A to G are used to be. During the operation to move the graphics representing the information A to H in this manner, when a graphic representing desired information appears in the selection candidate display area 212, a swipe operation performed by a user on the graphic representing the desired information in the direction indicated by a solid line arrow 242 causes the image processing apparatus 100 to display the graphic in a print target display area 222, the swipe operation being an example of the first operation, the print target display area 222 being an example of the second area of the operation stand 20. Although the solid line arrow 242 indicates a downward direction, and the dashed line arrow 232 indicates a rightward direction in the above, without being limited to this, the former may be a first direction, and the latter may be a second direction different from the first direction in a more generalized manner.

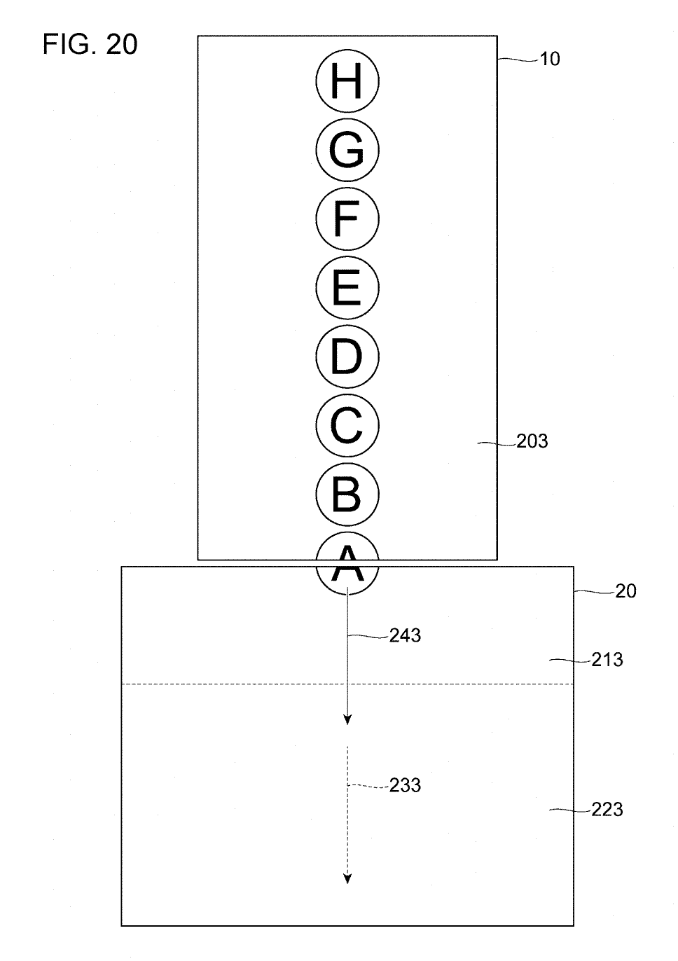

FIG. 20 is a view illustrating a screen display example displayed in the third mode of the public print processing in step 703 of FIG. 15. When a user approaches the image processing apparatus 100 with the stand-by screen 101 displayed, the image processing apparatus 100 displays on the guide display 10 a public print screen 203 in which the graphics representing the information A to H are aligned in a vertical row. At this point, the image processing apparatus 100 displays part of a graphic that represents the lowermost information A in a selection candidate display area 213 which is an example of the first area of the operation stand 20. In this state, when a user touches a print target display area 223 to perform a swipe operation in the direction indicated by a dashed line arrow 233, on the public print screen 203, the graphics representing the information B to H slide down to respective positions at which the graphics representing the information A to G are used to be, and the graphic representing the information A is moved to the position at which the graphic representing the information H is used to be, the print target display area 223 being an example of the second area, the swipe operation being an example of the second operation. During the operation to move the graphics representing the information A to H in this manner, when a graphic representing desired information appears in the selection candidate display area 213, a swipe operation performed by a user on the graphic representing the desired information in the direction indicated by a solid line arrow 243 causes the image processing apparatus 100 to display the graphic in the print target display area 223, the swipe operation being an example of the first operation.

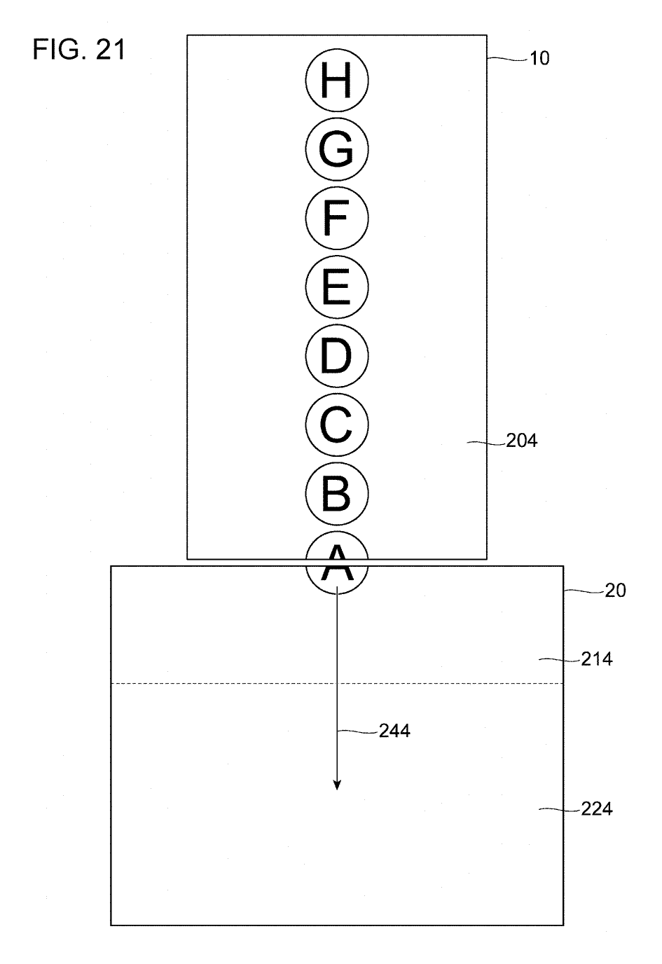

FIG. 21 is a view illustrating a screen display example displayed in the fourth mode of the public print processing in step 703 of FIG. 15. When a user approaches the image processing apparatus 100 with the stand-by screen 101 displayed, the image processing apparatus 100 displays on the guide display 10 a public print screen 204 in which the graphics representing the information A to H are aligned in a vertical row. At this point, the image processing apparatus 100 displays part of a graphic that represents the lowermost information A in a selection candidate display area 214 which is an example of the first area of the operation stand 20. Subsequently, the image processing apparatus 100 moves the graphics representing the information A to H without an operation of a user. In other words, when a predetermined time has elapsed, on the public print screen 204, the graphics representing the information B to H slide down to respective positions at which the graphics representing the information A to G are used to be, and the graphic representing the information A is moved to the position at which the graphic representing the information H is used to be. During movement of the graphics representing the information A to H in this manner, when a graphic representing desired information appears in the selection candidate display area 214, a swipe operation, which is an example of the first operation, performed by a user on the graphic representing the desired information in the direction indicated by a solid line arrow 244 causes the image processing apparatus 100 to display the graphic in a print target display area 224 which is an example of the second area of the operation stand 20.

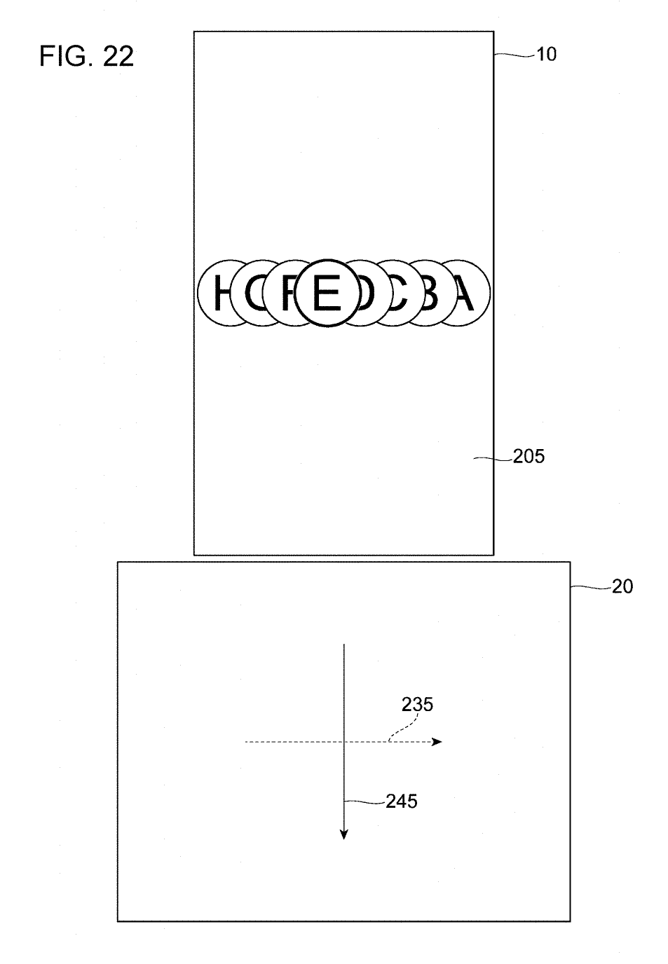

FIG. 22 is a view illustrating a screen display example displayed in the fifth mode of the public print processing in step 703 of FIG. 15. When a user approaches the image processing apparatus 100 with the stand-by screen 101 displayed, the image processing apparatus 100 displays on the guide display 10 a public print screen 205 in which the graphics representing the information A to H are aligned in a horizontal row. In this state, when a user touches the operation stand 20 to perform a swipe operation, which is an example of the second operation, in the direction indicated by a dashed line arrow 235, on the public print screen 205, the graphics representing the information B to H are moved to the respective positions at which the graphics representing the information A to G are used to be, and the graphic representing the information A is moved to the position at which the graphic representing the information H is used to be. During the operation to move the graphics representing the information A to H in this manner, when a graphic representing desired information is moved to the central position (indicated by enclosing with a thick line), a swipe operation, which is an example of the first operation, performed by a user on the graphic representing the desired information in the direction indicated by a solid line arrow 245 causes the image processing apparatus 100 to display the graphic on the operation stand 20. Although graphics are moved by a user performing a swipe operation in the rightward direction on the public print screen 205 in the description above, without being limited to this, for instance, when a predetermined time has elapsed, graphics may be moved without an operation of a user. Also, in the description above, when a graphic representing desired information is moved to the central position, a swipe operation performed by a user on the graphic causes the image processing apparatus 100 to display the graphic on the operation stand 20. However, without being limited to this, when a graphic representing desired information is in a predetermined state, a swipe operation performed by a user on the graphic may cause the image processing apparatus 100 to display the graphic on the operation stand 20 in a more generalized manner.

Although the order in which the graphics representing the information A to H are aligned has not been mentioned in the first to fifth modes, graphics may be displayed, for instance, in descending order of degree desired by a user in the selection candidate display areas 211 to 214 of the operation stand 20. Here, the degree desired by a user may be calculated based on attributes of a user, such as sex and age, which are obtained from an image of the user captured by the imager 60, for instance.

Also, in the public print processing in step 703 of FIG. 15, the above-described sixth and seventh modes may also be considered as a method to move a graphic representing desired information to the operation stand 20 from the graphics representing the information A to H displayed on the guide display 10.

First, the sixth mode of the public print processing in step 703 of FIG. 15 will be described. In the sixth mode, when a user performs an operation to indicate a position on the guide display 10, the image processing apparatus 100 identifies the position at which a graphic representing desired information is displayed, the graphic being one of the graphics representing the information A to H displayed on the guide display 10. Here, the “operation to indicate a position” includes glancing at the position at which a graphic representing desired information is displayed, and pointing at the position at which a graphic representing desired information is displayed. Accordingly, the image processing apparatus 100 changes the display mode of the graphic displayed at the identified position. For instance, in order to attract attention, the graphic displayed at the identified position is made greater than the other graphics or separated from the other graphics. Subsequently, when a swipe operation is performed by a user on the operation stand 20, the image processing apparatus 100 moves the graphic displayed at the identified position to the operation stand 20.

Next, the seventh mode of the public print processing in step 703 of FIG. 15 will be described. In the sixth mode, when a user performs an operation to indicate identification information of a graphic on the guide display 10 with finger, the image processing apparatus 100 identifies the identification information associated with the graphic representing desired information, the graphic being one of the graphics representing the information A to H displayed on the guide display 10. Here, when identification information is a number, the “operation to indicate identification information with finger” includes holding up fingers with the number of fingers being the number. Accordingly, the image processing apparatus 100 changes the display mode of the graphic associated with the identified identification information. For instance, the graphic associated with the identified identification information is made greater than the other graphics or separated from the other graphics to attract attention. Subsequently, when a swipe operation is performed by a user on the operation stand 20, the image processing apparatus 100 moves the graphic associated with the identified identification information to the operation stand 20.

Alignment of the graphics representing the information A to H has not been mentioned in the sixth and seventh modes, and this is because one of the graphics on the guide display 10 is directly identified by an operation of a user, and thus the order of the selected candidates of the graphics representing the information A to H does not have to be considered.

### [Operation Example at Time of Public Print Processing of Control Device]

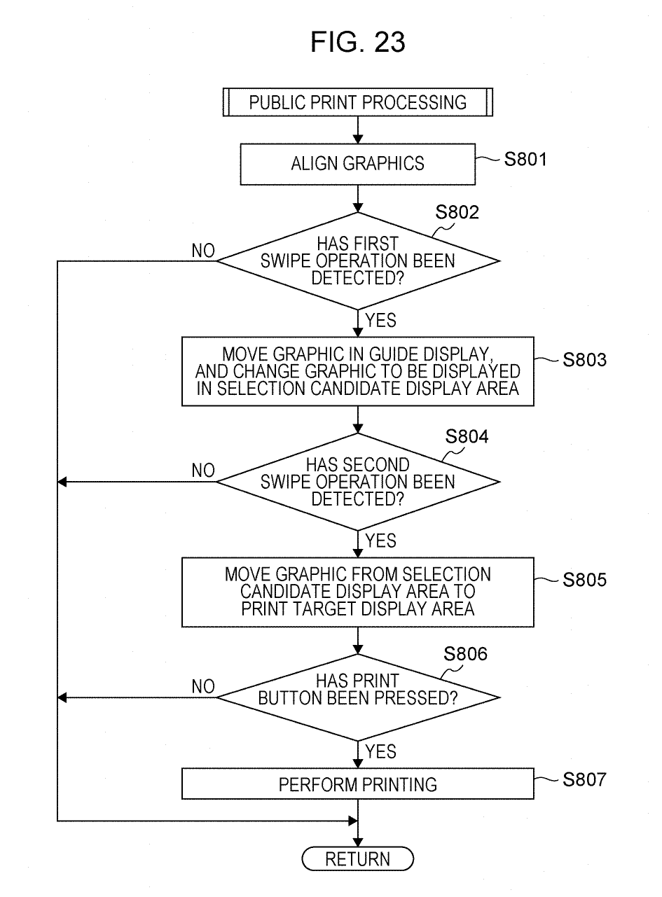

FIG. 23 is a flowchart illustrating an operation example of the control device 70 when the public print processing in step 703 of FIG. 15 is performed in the first to third modes.

As illustrated, in the control device 70, the display controller 71 first aligns and displays graphics representing information on the guide display 10 (step 801). Specifically, the graphics representing information are aligned and displayed in a vertical direction as in FIGS. 18 and 20 in the first and the third modes, and the graphics are aligned and displayed in a circular manner as in FIG. 19 in the second mode.

Subsequently, the detection controller 73 determines whether or not the first swipe operation on the operation stand 20 has been detected by the operation detector 40 (step 802). Here, the first swipe operation refers to the swipe operation in the direction indicated by the dashed line arrow 231 in FIG. 18 in the first mode, the swipe operation in the direction indicated by the dashed line arrow 232 in FIG. 19 in the second mode, and the swipe operation in the direction indicated by the dashed line arrow 233 in FIG. 20 in the third mode.

When it is determined the first swipe operation on the operation stand 20 has not been detected by the operation detector 40, the detection controller 73 ends the processing. On the other hand, when it is determined the first swipe operation on the operation stand 20 has been detected by the operation detector 40, the display controller 71 moves and displays the graphic in the guide display 10, and the projection controller 72 changes and displays the graphics in the selection candidate display area on the operation stand 20 using the projector 30 (step 803). Specifically, the graphics are moved in a vertical direction and displayed as in FIGS. 18 and 20 in the first and the third modes, and the graphics are moved in a circular direction and displayed as in FIG. 19 in the second mode.

Subsequently, the detection controller 73 determines whether or not the second swipe operation on the operation stand 20 has been detected by the operation detector 40 (step 804). Here, the second swipe operation refers to the swipe operation in the direction indicated by the solid line arrow 241 of FIG. 18 in the first mode, the swipe operation in the direction indicated by the solid line arrow 242 of FIG. 19 in the second mode, and the swipe operation in the direction indicated by the solid line arrow 243 of FIG. 20 in the third mode.

When it is determined the second swipe operation on the operation stand 20 has not been detected by the operation detector 40, the detection controller 73 ends the processing. On the other hand, when it is determined the second swipe operation on the operation stand 20 has been detected by the operation detector 40, the projection controller 72 moves and displays the graphic from the selection candidate display area to the print target display area on the operation stand 20 using the projector 30 (step 805).

Subsequently, the detection controller 73 determines whether pressing of the print button on the operation stand 20 is detected by the operation detector 40 (step 806). When it is determined that pressing of the print button on the operation stand 20 has not been detected by the operation detector 40, the detection controller 73 ends the processing, whereas when it is determined that pressing of the print button on the operation stand 20 has been detected by the operation detector 40, the print controller 74 performs control so that printing is made by the printer 50 (step 807).

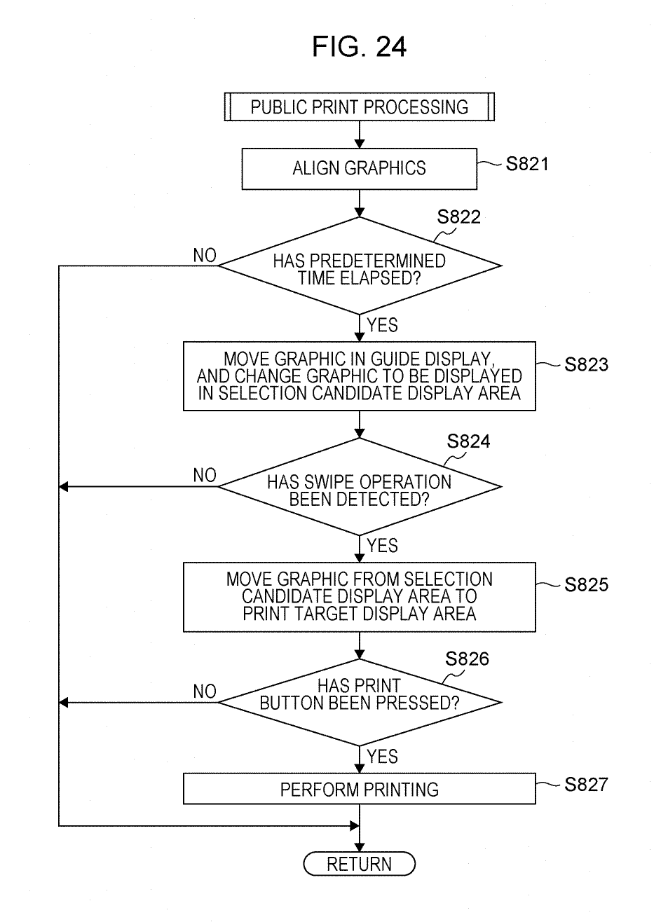

FIG. 24 is a flowchart illustrating an operation example of the control device 70 when the public print processing in step 703 of FIG. 15 is performed in the fourth mode.

As illustrated, in the control device 70, the display controller 71 first aligns and displays graphics representing information on the guide display 10 (step 821). Specifically, the graphics representing information are aligned and displayed in a vertical direction as in FIG. 21.

Subsequently, the display controller 71 determines whether or not a predetermined time has elapsed (step 822).

When it is determined that a predetermined time has not elapsed, the display controller 71 ends the processing. On the other hand, when it is determined that a predetermined time has elapsed, the display controller 71 moves and displays the graphic in the guide display 10, and the projection controller 72 changes and displays the graphics in the selection candidate display area on the operation stand 20 using the projector 30 (step 823). Specifically, the graphics are moved in a vertical direction and displayed as in FIG. 21.

Subsequently, the detection controller 73 determines whether or not a swipe operation on the operation stand 20 has been detected by the operation detector 40 (step 824). Here, the swipe operation refers to the swipe operation in the direction indicated by the solid line arrow 244 in FIG. 21.

When it is determined the swipe operation on the operation stand 20 has not been detected by the operation detector 40, the detection controller 73 ends the processing. On the other hand, when it is determined the swipe operation on the operation stand 20 has been detected by the operation detector 40, the projection controller 72 moves and displays the graphic from the selection candidate display area to the print target display area on the operation stand 20 using the projector 30 (step 825).

Subsequently, the detection controller 73 determines whether pressing of the print button on the operation stand 20 is detected by the operation detector 40 (step 826). When it is determined that pressing of the print button on the operation stand 20 has not been detected by the operation detector 40, the detection controller 73 ends the processing, whereas when it is determined that pressing of the print button on the operation stand 20 has been detected by the operation detector 40, the print controller 74 performs control so that printing is made by the printer 50 (step 827).

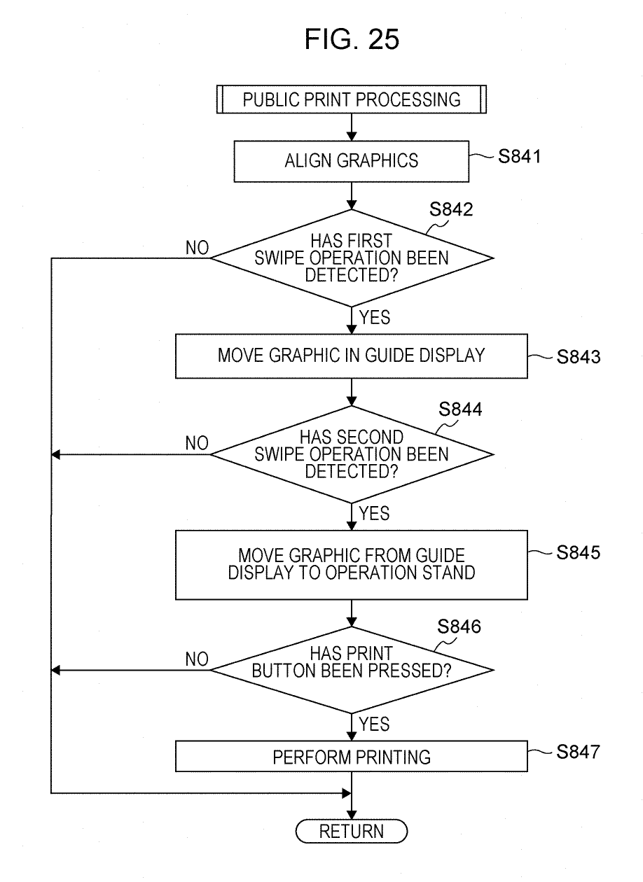

FIG. 25 is a flowchart illustrating an operation example of the control device 70 when the public print processing in step 703 of FIG. 15 is performed in the fifth mode.

As illustrated, in the control device 70, the display controller 71 first aligns and displays graphics representing information on the guide display 10 (step 841). Specifically, the graphics representing information are aligned and displayed in a horizontal direction as in FIG. 22.

Subsequently, the detection controller 73 determines whether or not the first swipe operation on the operation stand 20 has been detected by the operation detector 40 (step 842). Here, the first swipe operation refers to the swipe operation in the direction indicated by the dashed line arrow 235 in FIG. 22.

When it is determined the first swipe operation on the operation stand 20 has not been detected by the operation detector 40, the detection controller 73 ends the processing. On the other hand, when it is determined the first swipe operation on the operation stand 20 has been detected by the operation detector 40, the display controller 71 moves and displays the graphic in the guide display 10, and the projection controller 72 changes and displays the graphics in the selection candidate display area on the operation stand 20 using the projector 30 (step 843). Specifically, the graphics are moved in a horizontal direction and displayed as in FIG. 22.

Subsequently, the detection controller 73 determines whether or not the second swipe operation on the operation stand 20 has been detected by the operation detector 40 (step 844). Here, the second swipe operation refers to the swipe operation in the direction indicated by the solid line arrow 245 of FIG. 22.

When it is determined the second swipe operation on the operation stand 20 has not been detected by the operation detector 40, the detection controller 73 ends the processing. On the other hand, when it is determined the second swipe operation on the operation stand 20 has been detected by the operation detector 40, the display controller 71 and the projection controller 72 moves the graphic displayed on the central position of the guide display 10 to the operation stand 20 (step 845). Specifically, the display controller 71 deletes the graphic displayed on the central position of the guide display 10, and the projection controller 72 displays the deleted graphics on the operation stand 20 using the projector 30.

Subsequently, the detection controller 73 determines whether pressing of the print button on the operation stand 20 is detected by the operation detector 40 (step 846). When it is determined that pressing of the print button on the operation stand 20 has not been detected by the operation detector 40, the detection controller 73 ends the processing, whereas when it is determined that pressing of the print button on the operation stand 20 has been detected by the operation detector 40, the print controller 74 performs control so that printing is made by the printer 50 (step 847).

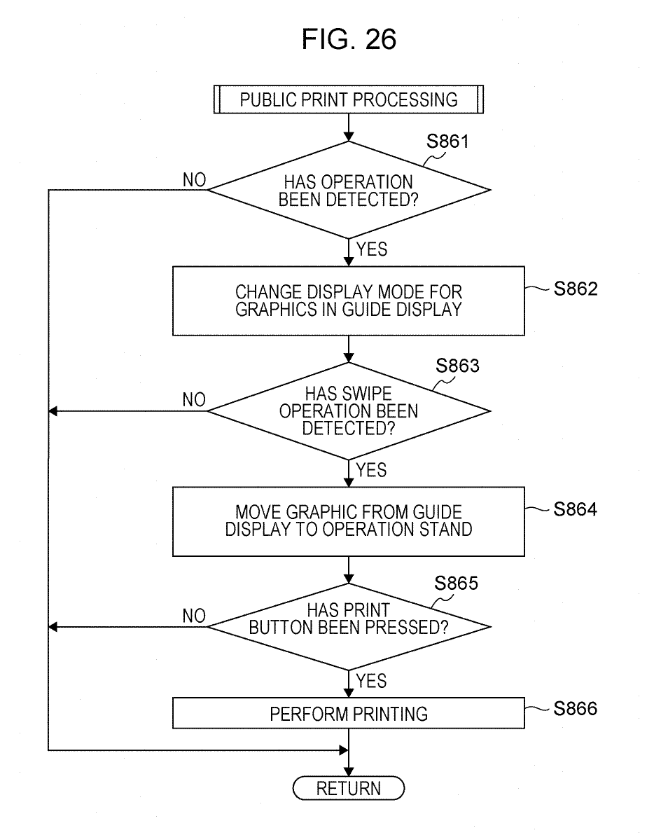

FIG. 26 is a flowchart illustrating an operation example of the control device 70 that performs the public print processing in the sixth and seventh modes.

As illustrated, in the control device 70, the imaging controller 75 first determines whether a predetermined operation of a user has been detected by the imager 60 (step 861). Here, the predetermined operation refers to designating a graphic on the guide display 10 by glancing or pointing at the graphic in the sixth mode, and designating a graphic on the guide display 10 by indicating the identification information of the graphic with finger in the seventh mode.

When it is determined that a predetermined operation of a user has not been detected by the imager 60, the imaging controller 75 ends the processing. On the other hand, when it is determined that a predetermined operation of a user has been detected by the imager 60, the display controller 71 displays the designated graphic on the guide display 10 in a changed display mode (step 862). Specifically, the designated graphic is made greater than the other graphics or separated from the other graphics to attract attention.

Subsequently, the detection controller 73 determines whether or not a swipe operation on the operation stand 20 has been detected by the operation detector 40 (step 863). Here, the swipe operation refers to the swipe operation in a direction to the near side of the operation stand 20, for instance.

When it is determined the swipe operation on the operation stand 20 has not been detected by the operation detector 40, the detection controller 73 ends the processing. On the other hand, when it is determined the swipe operation on the operation stand 20 has been detected by the operation detector 40, the display controller 71 and the projection controller 72 moves the designated graphic on the guide display 10 to the operation stand 20 (step 864). Specifically, the display controller 71 deletes the designated graphic on the guide display 10, and the projection controller 72 displays the deleted graphics on the operation stand 20 using the projector 30.

Subsequently, the detection controller 73 determines whether pressing of the print button on the operation stand 20 is detected by the operation detector 40 (step 865). When it is determined that pressing of the print button on the operation stand 20 has not been detected by the operation detector 40, the detection controller 73 ends the processing, whereas when it is determined that pressing of the print button on the operation stand 20 has been detected by the operation detector 40, the print controller 74 performs control so that printing is made by the printer 50 (step 866).

### [Program]

The processing performed by the control device 70 in the exemplary embodiment is prepared, for instance, as a program such as application software.

Specifically, any program that implements the exemplary embodiment is considered to be a program that causes a computer to implement a function of displaying multiple display elements on the first display surface which is not touch-sensitive, and a function of displaying a specific display element selected from the multiple display elements displayed on the first display surface by an operation performed on the second display surface.

Also any program that implements the exemplary embodiment is considered to be a program that causes a computer to implement a function of detecting an operation of an operator, a function of displaying multiple display elements on the first display surface which is not touch-sensitive, and a function of displaying a specific display element on the second display surface according to an operation performed on the second display surface, the specific display element being selected from the multiple display elements displayed on the first display surface by the detected operation.

It is to be noted that any program that implements the exemplary embodiment may be provided not only by a communication unit, but also by a recording medium such as a CD-ROM that stores the program.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display apparatus comprising:
a first display unit that displays a plurality of display elements on a first display surface, the first display surface being not touch-sensitive; and
a second display unit that displays a specific display element on a second display surface, the specific display element being selected, from the plurality of display elements displayed on the first display surface, by an operation performed on the second display surface.

2. The display apparatus according to claim 1,
wherein the second display unit displays all or part of at least one display element in a first area of the second display surface, the at least one display element being one of the plurality of display elements displayed on the first display surface, and displays the specific display element in a second area of the second display surface, the specific display element being selected from the at least one display element by a first operation that comes in contact with the first area of the second display surface.

3. The display apparatus according to claim 2,
wherein the second display unit displays all or part of one display element as all or part of the at least one display element, the one display element being one of the plurality of display elements displayed on the first display surface and displayed on a side near the second display surface.

4. The display apparatus according to claim 2,
wherein the second display unit displays all or part of the at least one display element of the plurality of display elements displayed on the first display surface, in the first area according to a second operation performed on the second display surface.

5. The display apparatus according to claim 4,
wherein the first operation is a swipe operation in a first direction, the swipe operation starting in the first area, and
the second operation is a swipe operation in a second direction, the swipe operation starting in the first area.

6. The display apparatus according to claim 4,
wherein the first operation is a swipe operation starting in the first area, and
the second operation is a swipe operation starting in the second area.

7. The display apparatus according to claim 2,
wherein the second display unit displays all or part of the at least one display element in the first area, the at least one display element being sequentially selected from the plurality of display elements displayed on the first display surface without an operation of an operator.

8. The display apparatus according to claim 1,
wherein the first display unit causes movement of the plurality of display elements displayed on the first display surface, and
the second display unit displays a display element as the specific display element on the second display surface, the display element being one of the plurality of display elements displayed on the first display surface and in a predetermined state by the movement when a first operation is performed.

9. The display apparatus according to claim 8,
wherein the first display unit causes movement of the plurality of display elements displayed on the first display surface according to a second operation.

10. The display apparatus according to claim 8,
wherein the first display unit causes movement of the plurality of display elements displayed on the first display surface without an operation of an operator.

11. A display apparatus comprising:
a detection unit that detects an operation of an operator;
a first display unit that displays a plurality of display elements on a first display surface, the first display surface being not touch-sensitive; and
a second display unit that displays a specific display element on a second display surface according to an operation performed on the second display surface, the specific display element being selected from the plurality of display elements displayed on the first display surface, by the operation detected by the detection unit.

12. The display apparatus according to claim 11,
wherein the operation is an operation to indicate a position on the first display surface on which the specific display element is displayed.

13. The display apparatus according to claim 12,
wherein the operation to indicate a position on the first display surface is an operation to glance at the position.

14. The display apparatus according to claim 12,
wherein the operation to indicate a position on the first display surface is an operation to point to the position.

15. The display apparatus according to claim 11,
wherein the operation is an operation to indicate identification information of the specific display element with finger.

16. A non-transitory computer readable medium storing a program causing a computer to execute a process, the process comprising:
displaying a plurality of display elements on a first display surface, the first display surface being not touch-sensitive; and
displaying a specific display element on a second display surface, the specific display element being selected from the plurality of display elements displayed on the first display surface, by an operation performed on the second display surface.
